(19) United States
(12) Patent Application Publication
(10) Pub. No.: US 2013/0026986 A1
(43) Pub. Date: Jan. 31, 2013

(54) TRANSFORMER-LEVEL MANAGEMENT OF POWER CONSUMPTION BY ONE OR MORE CONSUMERS

(71) Applicants: Sanjay Parthasarathy, Edina, MN (US); Soumitri N. Kolavennu, Blaine, MN (US); Datta Godbole, Plymouth, MN (US); Wendy Foslien, Woodbury, MN (US)

(72) Inventors: Sanjay Parthasarathy, Edina, MN (US); Soumitri N. Kolavennu, Blaine, MN (US); Datta Godbole, Plymouth, MN (US); Wendy Foslien, Woodbury, MN (US)

(73) Assignee: Honeywell International Inc., Morristown, NJ (US)

(21) Appl. No.: 13/191,351

(22) Filed: Jul. 26, 2011

(51) Int. Cl. H02J 7/00

(52) U.S. Cl. 320/109

(57) ABSTRACT

Various examples provide a system and method including receiving a plurality of electrical vehicle charge requests, receiving a plurality of additional electric load power requests, and controlling charging of the electrical vehicles in association with the plurality of electrical vehicle charge power requests. Various examples include modulating the charging of one or more of the electrical vehicles to maintain total power consumed by the electrical vehicles and a plurality of additional electric loads below a threshold power consumption rate.

### BACKGROUND

Electrical vehicles (“EVs”) are enjoying increasing popularity. These vehicles include prime-movers powered partially or entirely by battery. These batteries may be recharged by the consumer, at either a house or at a remote charging station. Each charging event presents unique challenge for the upstream transformer powering the charger, as charging can consume as much, or more, than other loads that currently share the transformer. Some vehicle battery charging processes consume around 7.2 kilowatts, and take place over several hours. Some vehicle battery charges draw around 30 amps at 240 volts. The power draw rating for an air conditioner (“A/C”) is about the same as the power draw for some electrical vehicles. These power draws place a heavy load on transformers.

Utilities install a single transformer per 4-6 houses in a neighborhood in some instances. If two or more of the households connected to a transformer charge an electrical vehicle at the same time, they could cause degradation in performance or even failure of the transformer, resulting in loss of electricity for all the households. Such failures can be exacerbated by variable pricing models in which the price of energy changes throughout the day. For example, multiple charges are anticipated when electricity prices go down, such as at night. These multiple requests undesirably tax transformers.

### SUMMARY

Various examples provide a system and method including receiving a plurality of electrical vehicle charge requests, receiving a plurality of additional electric load power requests, such as requests to power an air conditioner, and include controlling charging of the electrical vehicles in association with the plurality of electrical vehicle charge power requests. Various examples include modulating the charging of one or more of the electrical vehicles to maintain total power consumed by the electrical vehicles and a plurality of additional electric loads below a threshold power consumption rate.

### BRIEF DESCRIPTION OF THE DRAWINGS

FIG. 1 illustrates a graphical depiction of a system that controls power provided from a transformer to multiple consumers, according to some examples.

FIG. 2 is a block diagram of a system that controls power provided from a transformer to multiple consumers, according to some examples.

FIG. 3 illustrates a method of controlling the amount of power consumed by multiple consumers at a transformer, according to some examples.

FIG. 4 illustrates a method of controlling charging of the electrical vehicles in association with the plurality of electrical vehicle charge requests, according to some examples.

FIG. 5 is a diagram illustrating A/C function over time according to some examples.

FIG. 6 is a diagram illustrating EV charging function over time according FIG. 5.

FIG. 7 is a block diagram of a computer system for performing control functions according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Some existing energy management systems or methods measure energy consumption at the individual consumer level, such as at a house or commercial building. For example, a consumer can read their power meter to understand how much power is being consumed within his or her house. Some energy management systems or methods measure at the utility substation level. For example, a utility has information relating to power consumption at the substation, provided by monitoring equipment installed at the substation. However, systems and methods would benefit from improved measurement between the utility and the consumer such as the commercial building or house.

While existing approaches have been sufficient thus far, monitoring and controlling energy use at the individual user level, they cannot adequately address the added tax placed upon the electrical infrastructure by the increasing popularity of electrical vehicles. For example, an electrical vehicle can add 6 kilowatts to 17 kilowatts of load to the grid. In some instances, charging an electrical vehicle at a consumer site doubles energy consumption. As such, charging more than one electrical vehicle simultaneously in a neighborhood could cause transformer failure.

One solution is to replace transformers with higher-rated ones. However, such replacement is expensive and time consuming. Accordingly, the present subject matter provides systems and methods that control power consumption at the transformer level to avoid failure. These systems and methods address the proliferation of electrical vehicles using power infrastructure by providing transformer-level load management at the consumer or neighborhood level. The present subject matter provides an automatic control system to monitor the load at the transformer level, and modulate the delivery of power to loads, such as electrical vehicles, A/C, or other appliances at the individual user level.

As an example, consider a neighborhood with 4 electrical vehicles. The transformer experiences around 25-50 kilowatts of extra load, depending on how many of the electrical vehicles are charged at once, and what kind of charging is performed. Such heavy loading can trigger transformer overcurrent protection, which is expensive and time-consuming to repair or reset. Accordingly, several examples treat electrical vehicles in each house as controllable loads, and control charging times and charging rates of respective electrical vehicles.

Such control is to manage power consumption, such as by electrical vehicle charging, such as in a neighborhood, by limiting transformer-level power consumption to target levels or thresholds, such as by switching off an appliance or EV charger, or by reducing the charge rate of an EV. Thresholds are stored in a controller located near or on the transformer, in various examples. In some examples, charging is performed regardless of price signals related to the cost of electricity.

The present systems and methods provide several benefits. One benefit is that utilities can reduce or eliminate blown transformers. Another benefit is that customers are able to charge their electrical vehicles without the fear of an outage. Further, utilities that are not attuned to time of use rates can manage peak loads without relying on the customers to drop their loads. Demand response programs can take advantage of the connected loads and manage the connected loads at the transformer level.

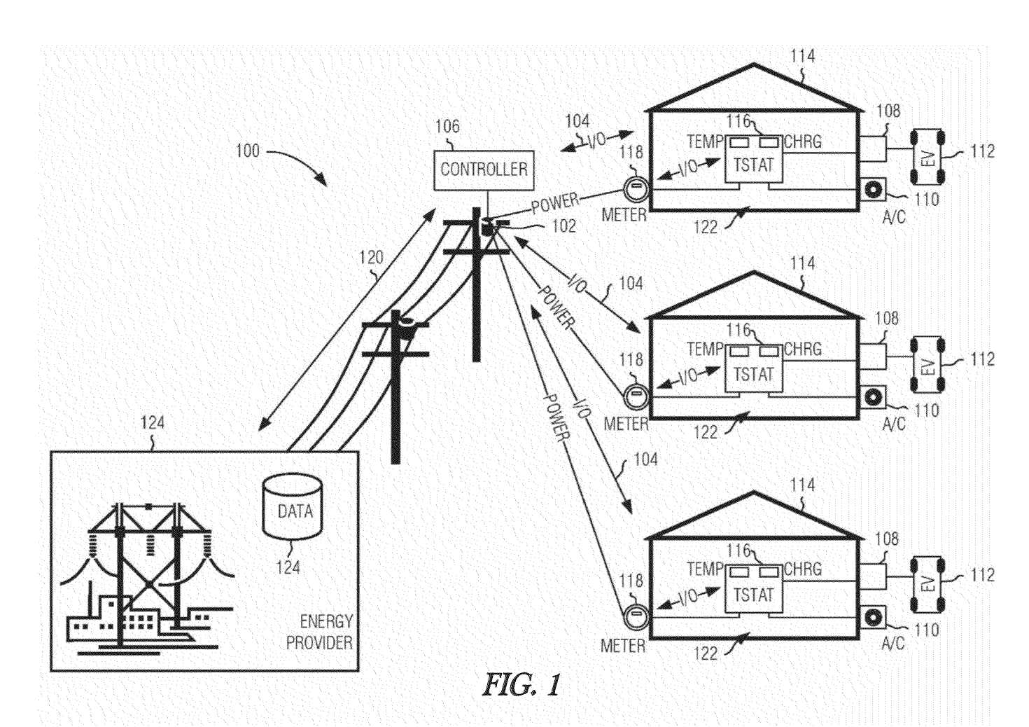

FIG. 1 illustrates a graphical depiction of a system that controls power provided from a transformer to multiple consumers, according to some examples. A consumer 114 includes, but is not limited to, a house, a commercial building, a unit within a building, or any other power destination such as a metered power destination. Various examples include all or part of a system 100 to control power consumption by a transformer such as a pole-top transformer 102. The controller 106 can reside on utility-owned assets (sub-stations, operations center), be deployed as a cloud solution either by the utility or a third-party energy service provider, or be deployed in conjunction with an Electric Vehicle Supply Equipment (EVSE) charging network or management system. In various examples, the transformer 102 is configured to power each electrical vehicle 112 that requests charging and to power each additional electric load 110 that requests powering, so long as the controller 106 permits it.

Various examples include a controller 106 to receive inputs and provide control signals on outputs from via the input/output sets 104. In various examples, the controller 106 is to modulate charging of one or more vehicles such as electrical vehicles 112 requesting charging. In various examples, the modulation is to maintain a total power consumption rate of a transformer 102 below a threshold power consumption rate. In some examples, the threshold power rate is 100% the rated power of the transformer, or a lower percentage. A total power consumption rate includes additional electric loads 110, which include, but are not limited to, HVAC devices such as air conditioner compressors, chillers, refrigerators, electric lights, other chargers, electric lawn-car tools, etc.

Examples include a plurality of input and output sets 104. A set includes one or more communication paths, such as a cable or radio frequency. In various examples, each set 104 comprises an electrical vehicle charging request input to receive an electrical vehicle charging request signal. In some examples, each set 104 includes an electrical vehicle battery charger output to couple to an electrical vehicle battery charger 108 to provide control signals to the electrical vehicle battery charger 108. In some examples, each set 104 includes an additional electric load power request input to receive an additional electric load power request signal. This input includes power requests from one or more additional electric loads. In some examples, each set 104 includes an additional electric load power output to provide control signals to the additional electric load to control powering of one or more additional electric loads.

In various examples, an electrical vehicle battery charger output from a controller 106 is to couple to the electrical vehicle 112 via a thermostat 116. In various examples, the additional electric load power output is to couple to one or more additional electric loads such as an air conditioner compressor 110 via the thermostat 116. In some examples, the thermostat is to control operation of one or more devices, such as charger 108 and the additional electric load 110.

Some examples use a smart home energy management (HEM) system or home area network (HAN) 122. In various examples, the HAN 122 monitors how much energy is being consumed by the house at any time. The load at the transformer 102 is also communicated to the HAN 122. The transformer 102 or the utility 112 advises the HAN 122 what action needs to be taken if the transformer 102 is loaded over a limit or threshold. As a result of such advisement, in some examples the HAN 122 schedules an electric load such as a charger 180 or an additional electric load 110 such as an appliance to turn on or off, or set the electrical vehicle 112 to a desired charge rate, such as trickle charge.

Various examples include a meter 118 to monitor the charging of one or more vehicles 112 such as EVs and the powering of one or more additional electric loads 110. In some examples, the meter 118 provides one or more electrical vehicle charging request signals associated with the charging of one or more electrical vehicles to the controller 106. In some examples, the meter 118 provides one or more additional electric load power request signals associated with the powering of one or more additional electric loads to the controller 106. In some examples, the meter 118 is a smart meter configured to monitor power consumption at a structure. Structures may be selected from the group include houses, multi-tenant buildings, commercial and industrial complexes and universities.

The present subject matter is not limited to a HAN 122, or to a smart meter 118. Various examples include any device that can access transformer load levels and transformer rated capacity, and that is programmable control electrical loads such as to modify a schedule of electric load use by a consumer 114.

In some examples, the controller 106 and/or a thermostat 116 senses which kinds of loads, and how many, are connected to the transformer 102 and uses the sensing to provide control. Some examples have breaker-level access and/or IP-addressing to sense which loads are connected.

In some examples, the controller 106 stores a record of the total power consumption rate over time. In some examples, the controller 106 outputs a total power consumption output to communicate a record of the total power consumption rate of the consumers 114, such as via communications 120 with a utility 124.

Controller 106 resides in various locations, according to several examples. In some examples, it resides at the transformer. In some examples, it resides at the sub-station where it receives the signals. In some examples, it resides at the utility operations center. In various examples, it could be deployed in the cloud, and be hosted and/or managed by a third party energy service provider. In some examples, it is hosted and/or managed by an Electric Vehicle Supply Equipment (EVSE) charging network or management system.

According to various examples, communications 120 occur via the utility back-haul, such as through the meter 118 such as a smart meter. In some examples, communications occur via an internet connection with the consumer 114. Some of these examples use authenticated access to the utility's data on transformer load. Some examples use communication nodes at the transformer 102 that can one or more electric loads in the consumer 114.

In various examples, a user manages power consumption at a consumer 114 to reduce or prevent instances of transformer over-stress. For example, a thermostat 116 can indicate that an EV 112 cannot be charged at a desired rate without overstressing a transformer 102, and as such, the EV will be charged at a reduced rate, or not at all, so long as additional electric loads 110 are operated. Accordingly, the user can choose to deactivate the additional electric loads 110. In some examples, if the user desires to override transformer-level control and limiting of his or her power consumption, he or she is assessed a higher price per kilowatt hour, and power is diverted from other consumers or from a reserve.

In various examples, control of power consumption from a transformer 102 can be input via programming a thermostat 116, such as to charge an EV only when the air conditioning is off. In various examples, the user can manage power consumption with an eye toward power instant power consumption instead of focusing more on electric costs.

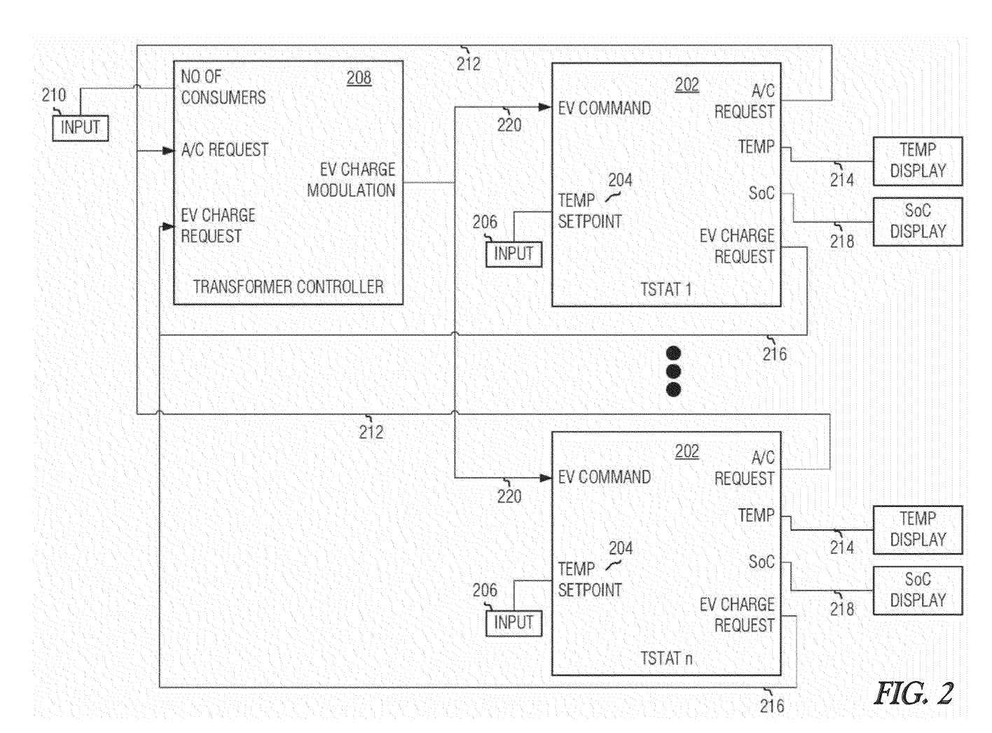

FIG. 2 is a block diagram of a system that controls power provided from a transformer to multiple consumers, according to some examples. A controller 208 provides signals to multiple consumers 202, shown as thermostats, to modulate the charging of electrical vehicles. Although the example shows a thermostat 202, another kind of controller can be used. In various examples, using information received from the controller 208, the thermostat 202 controls one or both an electrical vehicle charger and an additional electric load such as an air conditioning compressor to operate at desired times as described herein.

In various examples, a thermostat 202 receives a temperature set point 204, such as from an input 206. In various examples, an additional electric load power request is associated with a temperature setpoint of a thermostat. For example, a user inputs a desired temperature as a setpoint, and if the interior of the user's house is above the temperature setpoint, an additional electric load power request 212 is issued. In some examples, it is a request to operate an air conditioning compressor, but the present subject matter is not so limited. In some examples, the temperature setpoint is output 214 to a display. A display, as used herein can be graphical, or a signal presented over a communication path, such as to a connector.

In various examples, the thermostat 202 receives an EV charge request, such as when a user plugs in an electrical vehicle to charge it. In various examples, the EV charging request 216 and the additional electric load power request 212 are communicated to the transformer controller 208 which sums incoming EV charging request(s) and incoming additional electric load power request(s) and determines if they exceed a preprogrammed threshold. In various examples, the preprogrammed threshold is associated with a number of consumers coupled to a transformer to power each electrical vehicle charger and each additional electric load. The controller 208 is programmed with the number of consumers using the transformer via input 210.

In various examples, the controller 208 is to subtract power consumption by each additional electric load requesting powering from the threshold power consumption rate and to provide control signals to equally divide remaining power among each electrical vehicle requesting charging. A method example includes subtracting power consumption by each additional electric load requesting powering from the threshold power consumption rate and providing control signals to equally divide a remaining power among each electrical vehicle requesting charging.

In additional examples, the plurality of input and output sets each includes a vehicle state of charge input, and the controller is to modulate charging of each electrical vehicle separately, with electrical vehicles having a relatively lower state of charge receiving a relatively higher charging rate. A method example includes receiving a plurality of vehicle state of charge signals and modulating charging of each of the electrical vehicles separately, with an electrical vehicle having a relatively lower state of charge receiving a relatively higher charging rate than an electrical vehicle having a relatively higher state of charge.

In various examples, the controller provides a display of vehicle state of charge and/or charging state 218 for an electrical vehicle in association with the temperature setpoint. In some examples, the display of vehicle state of charge and/or charging state 218 is provided via the thermostat 202, but the present subject matter is not so limited. In various examples, the method includes modulating vehicle charging based on a threshold power consumption rate is associated with a number of houses coupled to a transformer to power each electrical vehicle charger and each additional electric load. In some examples, an example includes displaying charging possible for an electrical vehicle in association with the temperature setpoint.

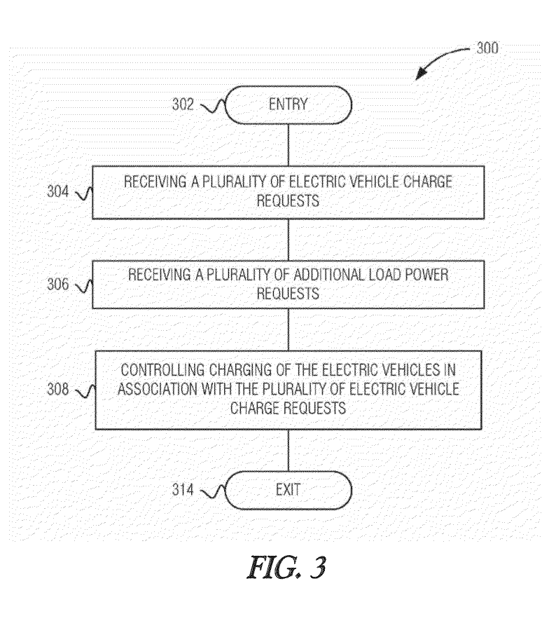

FIG. 3 illustrates a method of controlling the amount of power consumed by multiple consumers at a transformer, according to some examples. At 302, the method begins. At 304, the method includes receiving a plurality of electrical vehicle charge requests. At 306, the method includes receiving a plurality of additional electric load power requests. At 308, the method includes controlling charging of the electrical vehicles in association with the plurality of electrical vehicle charge requests.

In some examples, the method includes receiving at least one additional electric load request from a thermostat. In some examples, the method includes controlling operation of the plurality of additional electric loads in association with the plurality of additional electric load power requests.

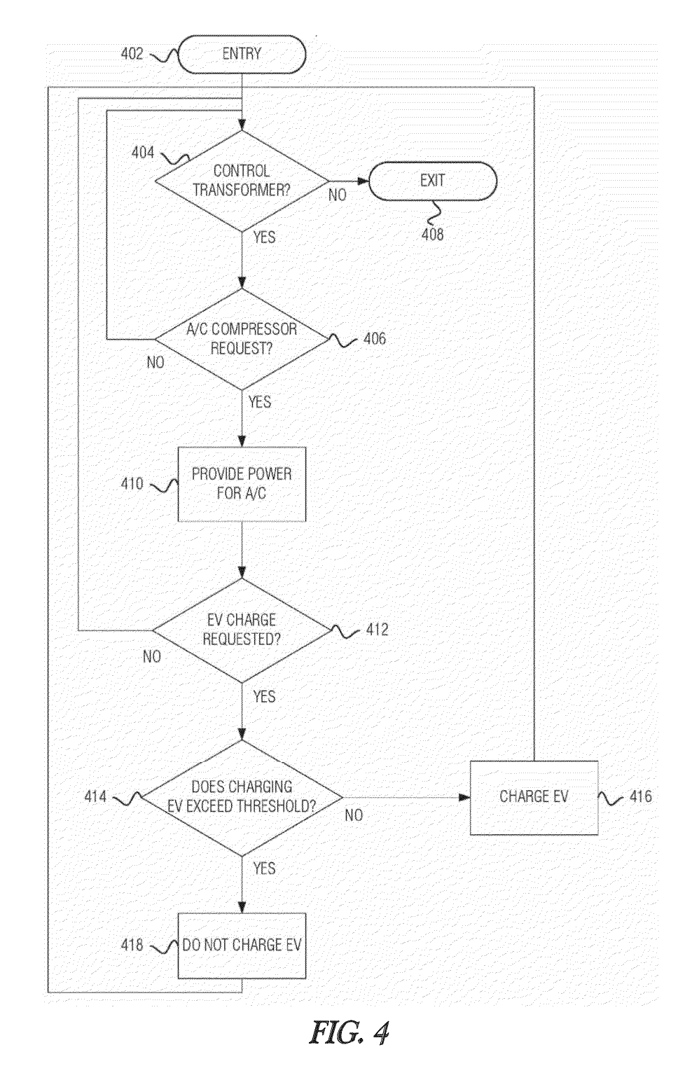

FIG. 4 illustrates a method of controlling charging of the electrical vehicles in association with the plurality of electrical vehicle charge requests, according to some examples. At 402, the method begins. At 404, the method queries whether there is an instruction to control the transformer. Such an instruction is input at the transformer control, such as via communications with a utility. If the transformer is to be controlled, the method proceeds to query 406 whether an additional electric load, such as an air conditioner compressor, is requested to be engaged. If the transformer is not to be controlled, the method ends 408, although the method may continuously loop to repeatedly query whether the transformer is to be controlled.

If the additional load is engaged, at 410 the method provides power for the additional electric load. At 412, the method queries whether an EV charge is requested. If an EV charge is requested, the method calculates whether charging the EV will exceed a predetermined or preprogrammed threshold. If it does not, the method charges the EV at 416. If it does, it issues an instruction to forego charging 418 and repeats to step 402. In some methods, rather than foregoing charging, charging at the maximum limit possible without exceeding the threshold is performed.

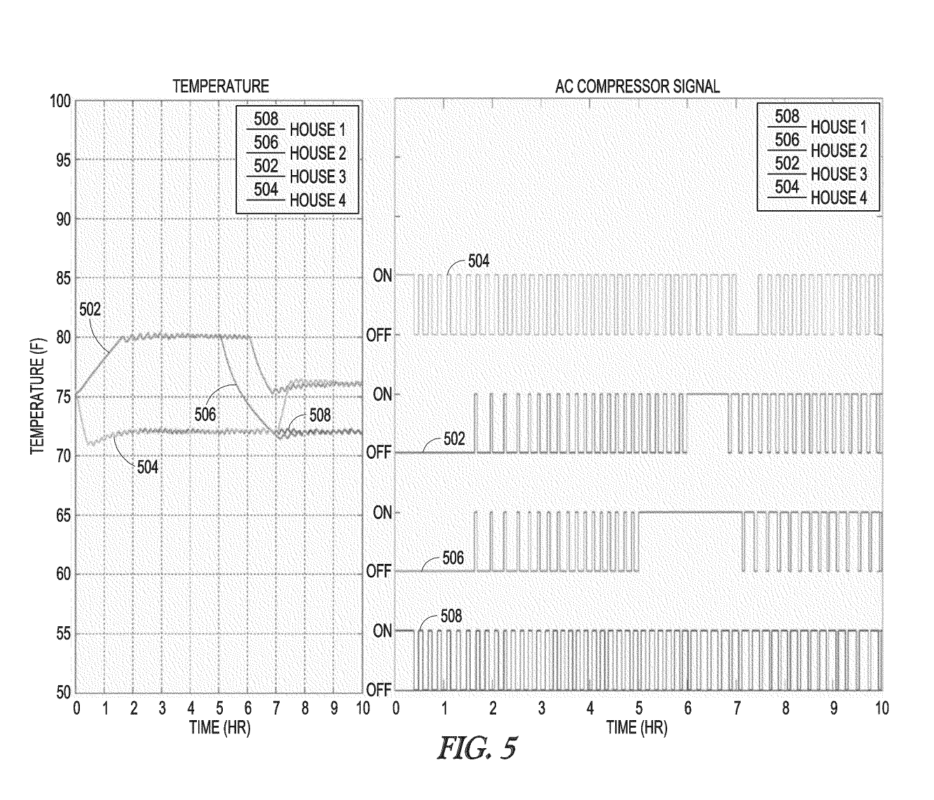

FIG. 5 is a diagram illustrating A/C function over time according to some examples. Four consumers or houses are shown, 502, 504, 506 and 508. Ambient temperature is above 80 degrees Fahrenheit. At time zero, house 502 enters a setpoint request of 80 degrees at zero hours, to be adjusted down to 76 degrees after 6 hours. House 504 enters a temperature setpoint of 72 degrees at zero hours, to be adjusted to 76 degrees at seven hours. At time zero, house 506 enters a setpoint request of 80 degrees at zero hours, to be adjusted down to 72 degrees after 5 hours. At time zero, house 508 enters a setpoint request of 72 to be maintained throughout the example. The transformer is a conventional transformer, designed for and having a capacity rating for 5 homes without electrical vehicle charging. The A/C Compressor Signal chart represents the signal provided to an A/C compressor to power the compressor, with the high-side of the signal representing powering of the A/C, and the low-side representing the A/C not powered. The diagram shows that the air conditioner compressors run to achieve desired cooling, irrespective of EV charging, so long as there is sufficient power to power all of the air conditioner compressor.

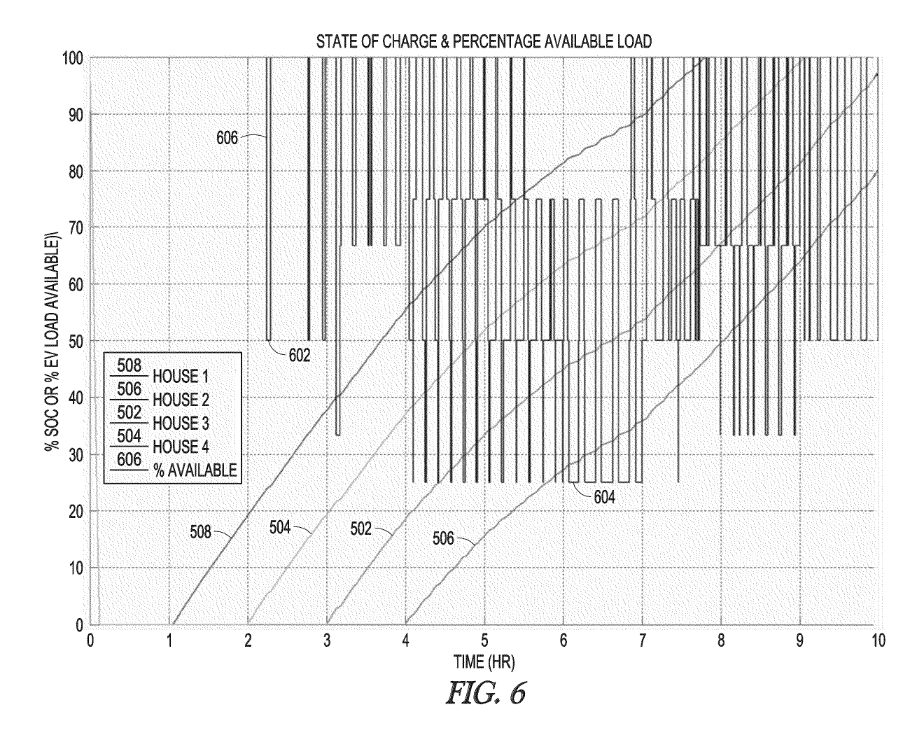

FIG. 6 is a diagram illustrating EV charging function over time according FIG. 5. At time 602, a number of A/C compressors are running as set forth in FIG. 5, and houses 1 and 2 are requesting an EV charge. The total load on the transformer from the A/C compressors reduces capacity available for EV charging to 50%. Accordingly, each of the EVs at houses 1 and 2 are charged at 25% of their requested charge rate, and their % state of charge increases less quickly as a result. At time 604, a number of A/C compressors are running as set forth in FIG. 5, and houses 1 through 4 are requesting an EV charge. The total load on the transformer from the A/C compressors reduces capacity available for EV charging to 25%. Accordingly, each of the EVs at houses 1 through 4 are charged at 6.25% of their requested charge rate, and their % state of charge increases less quickly as a result. Similar phenomena are depicted elsewhere on the chart.

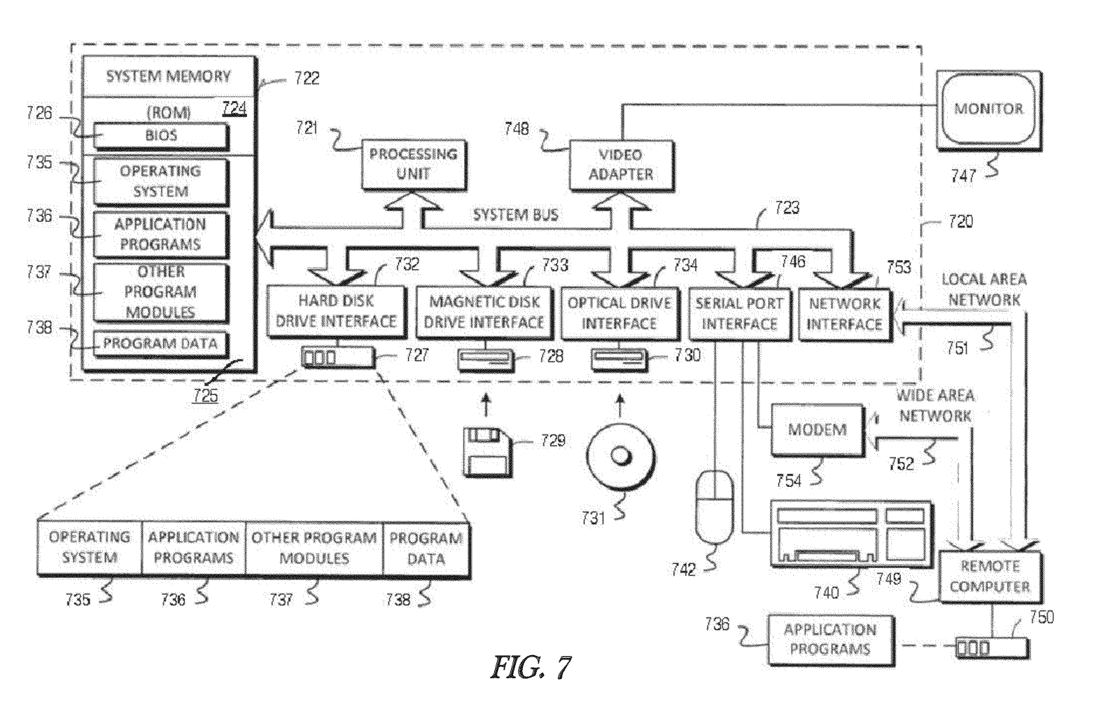

FIG. 7 is a block diagram of a computer system to implement methods according to an example embodiment. In the embodiment shown in FIG. 7, a hardware and operating environment is provided that is applicable to processing components in the transformer controller and functions it implements, although the hardware and operating environment is also applicable to processing components in the thermostat controller or an energy management system, or a HAN, and functions it implements.

As shown in FIG. 7, one embodiment of the hardware and operating environment includes a general purpose computing device in the form of a computer 700 (e.g., a personal computer, workstation, or server), including one or more processing units 721, a system memory 722, and a system bus 723 that operatively couples various system components including the system memory 722 to the processing unit 721. There may be only one or there may be more than one processing unit 721, such that the processor of computer 700 comprises a single central-processing unit (CPU), or a plurality of processing units, commonly referred to as a multiprocessor or parallel-processor environment. In various embodiments, computer 700 is a conventional computer, a distributed computer, or any other type of computer.

The system bus 723 can be any of several types of bus structures including a memory bus or memory controller, a peripheral bus, and a local bus using any of a variety of bus architectures. The system memory can also be referred to as simply the memory, and, in some embodiments, includes read-only memory (ROM) 724 and random-access memory (RAM) 725. A basic input/output system (BIOS) program 726, containing the basic routines that help to transfer information between elements within the computer 700, such as during start-up, may be stored in ROM 724. The computer 700 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media.

The hard disk drive 727, magnetic disk drive 728, and optical disk drive 730 couple with a hard disk drive interface 732, a magnetic disk drive interface 733, and an optical disk drive interface 734, respectively. The drives and their associated computer-readable media provide non volatile storage of computer-readable instructions, data structures, program modules and other data for the computer 700. It should be appreciated by those skilled in the art that any type of computer-readable media which ca store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 729, optical disk 731, ROM 724, or RAM 725, including an operating system 735, one or more application programs 736, other program modules 737, and program data 738. Programming for implementing one or more processes or method described herein may be resident on any one or number of these computer-readable media.

A user may enter commands and information into computer 700 through input devices such as a keyboard 740 and pointing device 742. Other input devices (not shown) can include a microphone, joystick, game pad, satellite dish, scanner, or the like. These other input devices are often connected to the processing unit 721 through a serial port interface 746 that is coupled to the system bus 723, but can be connected by other interfaces, such as a parallel port, game port, or a universal serial bus (USB). A monitor 747 or other type of display device can also be connected to the system bus 723 via an interface, such as a video adapter 748. The monitor 747 can display a graphical user interface for the user. In addition to the monitor 747, computers typically include other peripheral output devices (not shown), such as speakers and printers.

The computer 700 may operate in a networked environment using logical connections to one or more remote computers or servers, such as remote computer 749. These logical connections are achieved by a communication device coupled to or a part of the computer 700; the invention is not limited to a particular type of communications device. The remote computer 749 can be another computer, a server, a router, a network PC, a client, a peer device or other common network node, and typically includes many or all of the elements described above I/0 relative to the computer 700, although only a memory storage device 750 has been illustrated. The logical connections depicted in FIG. 7 include a local area network (LAN) 751 and/or a wide area network (WAN) 752. Such networking environments are commonplace in office networks, enterprise-wide computer networks, intranets and the internet, which are all types of networks.

When used in a LAN-networking environment, the computer 700 is connected to the LAN 751 through a network interface or adapter 753, which is one type of communications device. In some embodiments, when used in a WAN-networking environment, the computer 700 typically includes a modem 754 (another type of communications device) or any other type of communications device, e.g., a wireless transceiver, for establishing communications over the wide-area network 752, such as the internet. The modem 754, which may be internal or external, is connected to the system bus 723 via the serial port interface 746. In a networked environment, program modules depicted relative to the computer 700 can be stored in the remote memory storage device 750 of remote computer, or server 749. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. It could be deployed either on the premises, at the utility's assets, or on a cloud-based infrastructure.

What is claimed is:

1. A system, comprising:
a transformer, with a plurality of structures coupled to the transformer;
a plurality of input and output sets, each extending from the transformer to a respective structure, each set comprising:
an electrical vehicle charging request input to receive an electrical vehicle charging request signal;
an electrical vehicle battery charger output to couple to an electrical vehicle battery charger to provide control signals to the electrical vehicle battery charger; and
an additional electric load power request input to receive an additional electric load power request signal; and
a controller to receive the request inputs and provide the control signals on the electric vehicle battery charger outputs to modulate charging of one or more electrical vehicles requesting charging,
wherein the modulation is to maintain a total power consumption rate of the transformer below a threshold power consumption rate, and
wherein the transformer is configured to power each electrical vehicle that requests charging and to power each additional electric load that requests powering.

2. The system of claim 1 wherein at least one set includes an additional electric load power output to provide control signals to the additional electric load to control powering of the additional electric load.

3. The system of claim 2, wherein the electrical vehicle battery charger output is to couple to the electrical vehicle via a thermostat, and the additional electric load power output is to couple to the additional electric load via the thermostat.

4. The system of claim 1 wherein the threshold power consumption rate is based on a number of structures coupled to a transformer to power each electrical vehicle charger and each additional electric load.

5. The system of claim 1 wherein at least one additional electric load includes an air conditioner, and the additional electric load power request is associated with a temperature setpoint of a thermostat of the air conditioner.

6. The system of claim 5 wherein the controller is to display charging possible for an electrical vehicle in association with the temperature setpoint.

7. The system of claim 1 wherein the controller is to subtract power consumption by each additional electric load requesting powering from the threshold power consumption rate and to provide control signals to equally divide remaining power among each electrical vehicle requesting charging.

8. The system of claim 1, wherein the plurality of input and output sets each includes a vehicle state of charge input, and the controller is to modulate charging of each electrical vehicle separately, with electrical vehicles having a relatively lower state of charge receiving a relatively higher charging rate.

9. The system of claim 1, further comprising a meter to power consumption at a structure to monitor one electrical vehicle charging and one additional electric load powering and to provide one electrical vehicle charging request signal associated with the one electrical vehicle charging and one additional electric load power request signal associated with the one additional electric load powering.

10. The system of claim 9, wherein the meter is a smart meter configured to monitor power consumption for the structure.

11. The system of claim 1, wherein the controller is to store a record of the total power consumption rate over time, and further comprising a total power consumption output to communicate the record of the total power consumption rate.

12. A method comprising:
receiving a plurality of electrical vehicle charge requests from a respective plurality of structures;
receiving a plurality of additional electric load power requests from the plurality of structures; and
controlling charging of the electrical vehicles in association with the plurality of electrical vehicle charge requests by modulating the charging of one or more of the electrical vehicles to maintain total power consumed by the electrical vehicles and a plurality of additional electric loads below a threshold power consumption rate.

13. The method of claim 12 wherein the threshold power consumption rate is associated with a number of structures coupled to a transformer to power each electrical vehicle charger and each additional electric load.

14. The method of claim 12 comprising receiving at least one additional electric load request from a thermostat.

15. The method of claim 12, comprising controlling operation of the plurality of additional electric loads in association with the plurality of additional electric load power requests.

16. The method of claim 15, wherein controlling operation of the plurality of additional electric loads in association with the plurality of additional electric load power requests comprises controlling an air conditioner in association with a temperature setpoint.

17. The method of claim 16, comprising displaying charging possible for an electrical vehicle in association with the temperature setpoint.

18. The method of claim 12 comprising subtracting power consumption by each additional electric load requesting powering from the threshold power consumption rate and providing control signals to equally divide a remaining power among each electrical vehicle requesting charging.

19. The method of claim 12 comprising receiving a plurality of vehicle state of charge signals and modulating charging of each of the electrical vehicles separately, with an electrical vehicle having a relatively lower state of charge receiving a relatively higher charging rate than an electrical vehicle having a relatively higher state of charge.

20. The method of claim 12, further comprising monitoring one electrical vehicle and one air conditioner with a smart meter, and providing one electrical vehicle charge request and one additional electric load power request, associated with operation of the air conditioner, with the smart meter.
